(19) United States
(12) Patent Application Publication
(10) Pub. No.: US 2002/0040768 A1
(43) Pub. Date: Apr. 11, 2002

(54) High pressure, solid phase-forming apparatus and process

(75) Inventors: Percy K. Sagar, Olathe, KS (US); Kevin E. McCosh, Bonner Springs, KS (US); Christopher S. Walker, Overland Park, KS (US); James O. Borgen, Lee's Summit, MO (US)

Correspondence Address: HOVEY WILLIAMS TIMMONS & COLLINS, 2405 GRAND BLVD., SUITE 400, KANSAS CITY, MO, 64108

(73) Assignee: Preco Industries, Inc.

(21) Appl. No.: 09/953,009

(22) Filed: Sep. 11, 2001

Related U.S. Application Data
(60) Provisional application No. 60/231,877, filed on Sep. 12, 2000.

(51) Int. Cl. B32B 31/00

(52) U.S. Cl. 156/364; 156/382

(57) ABSTRACT

Apparatus and a method is provided for high pressure, solid phase forming of an image bearing relatively thin sheet. Each sheet to be formed is moved to a pickup station, the sheet is picked up by a heated vacuum pickup, and then transferred to a preheat station while held by the heated vacuum pickup. The heated vacuum pickup is lowered at the preheat station to bring the sheet into engagement with preheater structure therebelow so that heat is applied by direct engagement to both sides of the sheet at the preheat station. The preheated sheet, still attached by vacuum to the heated vacuum pickup is then moved into a forming station of a floating bolster supported die set assembly while the pressure chamber die set unit and a forming die set unit of the die set assembly are in vertically spaced relationship. The sheet is registered with the forming die while retained on the heated vacuum pickup by X axis adjustment of the pickup supporting the sheet and Y and θ axis adjustment of the bolster supporting the die set assembly. The sheet is next transferred to a vacuum frame surrounding a forming die of the lower die set unit, the pressure chamber die set unit is lowered into engagement with the vacuum frame, vacuum is transferred from the heated vacuum pickup to the vacuum frame so that the sheet as now held by the vacuum frame and high pressure fluid is introduced into the pressure chamber die set unit to pressure form the sheet against the forming die. Lifting of the pressure chamber die set unit allows the vacuum frame to strip the formed sheet from the forming die permitting the sheet to be removed from the die set and delivered to an off-loading conveyor.

### RELATED APPLICATION

This is a non-provisional application claims the benefit under 37 CFR §1.78 of provisional Application Serial No. 60/231,877 filed Sep. 12, 2000 entitled, High Pressure Solid Phase-Forming Apparatus and Process, which is fully incorporated herein by specific reference thereto.

### BACKGROUND

1. Field of the Invention

This invention relates generally to improved apparatus and a method for high pressure, solid phase forming of relatively thin sheets of various materials and particularly to deep drawing of synthetic resin film material that has been premarked with surface decoration or image information. Deep drawn formed plastic products having surface decoration or image information is generally referred to in the trade as “in-mold” or “insert mold” decorating (IMD).

Specifically, the invention relates to apparatus and a process for high pressure solid phase-forming apparatus that has particular utility for IMD manufacture of decorated plastic film items, or for deep drawing of various types of relatively thin sheet material. The apparatus may therefore be employed to process synthetic resin materials, laminated materials, including metals and laminated metals, and materials that have been coated with a decorative design or printed information, either in the form of, for example, an ink film applied by conventional printing or screen printing, vacuum-evaporated metallic thin film, or similar products, including electrically conductive varnish film, or similar layers.

Deep drawing of sheet material bearing an image-bearing section is facilitated by preheating of the sheet material to a level preferably below its glass transition stage temperature (T_{G}). A relatively high isostatic fluid pressure is then applied to the softened sheet material to deform the sheet and in certain instances at least a portion of the image section into a relatively deep die cavity.

Preheating of the sheet material to a level below its T_{G} temperature prior to forming requires controlled handling of the sheet material so that the image section of the sheet remains precisely aligned with the forming die unit of the separable die set assembly. The apparatus and process hereof therefore includes mechanism for assuring precise alignment of each of the preheated design or image-bearing sections of the sheet with the deep-draw die set unit, and to accomplish such alignment at a rapid rate.

An especially important advantage of this invention is that major operating components of hydraulically actuated, sheet-fed die and platen press equipment conventionally employed for die cutting, stamping and for embossing processes may be used as operating components of the present apparatus.

2. Description of the Prior Art

Niebling, Jr. et al. U.S. Pat. No. 5,108,530 issued Apr. 28, 1992, and assigned to Bayer Aktiengesellschaft, relates to a method of producing a deep drawn plastic piece in which a sheet of synthetic resin material is provided with a image-defining coating, and the image section of the sheet is preheated and then deep drawn under air pressure of more than 20 bars and preferably about 200 bars.

Raney et al. U.S. Pat. No. 4,555,968 issued Dec. 3, 1985, and assigned to Preco Industries, Inc., relates to web-fed die cutting presses having an automatic three axis die registration system. In the '968 patent, a movable die element of the die set may be shifted after an image-bearing section fo the web is moved into position in the die set to register the die element with indicia on the web along X (longitudinal), Y (transverse) and θ (rotational) axes.

Raney U.S. Pat. No. 4,697,485 issued Oct. 6, 1987 and assigned to Preco Industries, Inc., relates to a die press of the type illustrated in the '968 patent and which has a three axis (X, Y, θ) registration system which is operable to register a movable die element of the die set with an image bearing section of the web as the material is advanced into position in the die set.

Raney et al., U.S. Pat. No. 5,212,647 issued May 18, 1993 and assigned to Preco Industries, Inc. relates to a die stamping, cutting and embossing press having a CCD camera vision system for automatic X, Y and θ die registration with an image bearing web of relativity thin film material.

### SUMMARY OF THE INVENTION

The high pressure solid phase forming apparatus of this invention is useful for deep drawing of image bearing relatively thin sheet material and especially synthetic resin film sheets. The apparatus includes a die set assembly provided with a forming die unit and opposed high fluid pressure chamber die unit. A sheet to be formed is placed between the die set units while in spaced apart relationship, the die set units are closed on the sheet and a fluid such as compressed air is directed into the pressure chamber die unit to force the sheet material into conforming relationship with a forming die making up a part of the forming die unit. The high pressure of the fluid is then released, the die set units are separated and the formed part is removed from the die set.

In one form of the invention, mechanism for delivering individual sheets of material to a forming position in the die set assembly includes a loading station support for the sheet to be formed that includes registration pins, stops or clamps that serve to assure successive positioning of individual sheets in the same precise, predetermined position on the loading station support. The support with the registered sheet thereon is moved to a pickup station where a heated vacuum pickup is moved downwardly into engagement with the upper face of the sheet, a vacuum is applied and the sheet pickup is raised to lift the sheet while retaining the sheet without movement relative to the pickup.

The pickup with the sheet adhering thereto under the applied vacuum and while the sheet is subjected to heat from the pickup is moved to a preheat station adjacent to but outside of the die set assembly of the apparatus. The heated pickup is lowered while the applied vacuum is maintained to bring the sheet into contact with underlying heater structure. The heated pickup and the heater structure both in direct surface contact with the sheet cooperate to preheat the sheet to a predetermined temperature, preferably below T_{G} in the case of a synthetic resin film, while the sheet is clamped between the pickup and the heater structure.

The pickup is again raised along with the sheet adhering to the bottom of the pickup by virtue of the applied vacuum, and then transferred to a forming position between the spaced apart die set units. Lowering of the pickup within the die set assembly causes the sheet held by the pickup to be lowered onto a vacuum frame which is a part of the forming die unit and located in surrounding relationship to a forming die member of the die set assembly. The vacuum to the pickup is discontinued and vacuum is applied to the vacuum frame thereby causing the sheet to now be firmly held by the vacuum frame.

The pressure chamber die set unit is lowered into engagement with the vacuum frame, and high pressure fluid is introduced into the pressure chamber causing the sheet material to be formed against the forming die of the member forming die unit. Raising of the pressure chamber die unit releases the formed sheet so that it may be removed from the die set assembly.

Registration of the image of the sheet with the forming die of the forming die unit is assured by virtue of the fact that the sheet is held at all times from initial registration on the sheet support through pickup, preheating and final forming of the sheet in the forming die assembly.

In a preferred form of the invention, the die set assembly is mounted on a floating bolster forming a part of the press and that has Y and θ adjustment mechanism controlled by a CCD camera vision system. In this instance, rather than relying on sheet registration structure at the sheet loading station, the registration of an image on the sheet to be formed with the forming die unit of the die set assembly is carried out while the sheet is located at the forming station between the die set units of the die set assembly. A sheet to be formed is transferred to the forming position between the spaced apart die members of the die set assembly in the same manner as previously described. The vision registration system determines the adjustment that must be made in the position of the sheet with respect to the forming member of the die set assembly. The CCD camera vision system compares the position of the image bearing sheet with stored data regarding the desired position of the sheet in the die set assembly and X axis adjustment of the pickup and Y and θ axis adjustment of the die set assembly is carried out while the sheet is retained on the pickup. After X, Y and θ registration has been performed, the pickup carrier lowers the sheet onto the vacuum frame therebelow and forming of the sheet is accomplished as described.

An automatic sheet feeder may be provided for delivering individual sheets to the pickup station, in lieu of manual loading of the sheets.

### BRIEF DESCRIPTION OF THE DRAWINGS

FIG. 1 is a perspective view of press apparatus for high pressure, solid phase forming of relatively thin sheet material in accordance with a preferred embodiment of the invention;

FIG. 2 is a side elevational view of the press apparatus as illustrated in FIG. 1 and showing the sheet pickup station, a preheat station adjacent the main press structure, a die unit assembly mounted in the press apparatus, and formed sheet delivery mechanism for removing a formed sheet from the die set assembly, with the heated vacuum pickup being illustrated at the pickup station in disposition to pickup a sheet from a delivery tray support;

FIG. 3 is a side elevational view similar to FIG. 2 and illustrating the heated vacuum pickup at the preheat station adjacent the die set assembly of the press;

FIG. 4 is a side elevational view of the press apparatus showing the pickup at the forming station between the spaced apart die set units of the die set assembly;

FIG. 5 is a horizontal cross sectional view taken substantially along the line 5-5 of FIG. 2 and looking downwardly in the direction of the arrows;

FIG. 6 is a horizontal cross sectional view similar to FIG. 5 and illustrating the sheet loading support tray in the position thereof beneath the heated vacuum pickup, and with the sheet removal mechanism of the formed sheet delivery station in the position thereof within the die set assembly ready for pickup of a formed sheet;

FIG. 7 is a horizontal cross sectional view taken substantially along the line 7-7 of FIG. 3, looking downwardly in the direction of the arrows, and illustrating the heated vacuum pickup in the position thereof at the preheat station adjacent the die set assembly;

FIG. 8 is a horizontal cross sectional view taken substantially along the line 8-8 of FIG. 4, looking downwardly in the direction of the arrows, and illustrating the heated vacuum pickup at the sheet forming station within the die set assembly;

FIG. 9 is an enlarged, central, fragmentary longitudinal cross sectional view of the apparatus of the preceding figures;

FIG. 10 is a fragmentary vertical cross sectional view of the heated vacuum pickup;

FIG. 11 is a fragmentary exploded view of the heated vacuum pickup as illustrated in FIG. 10;

FIG. 12 is a fragmentary exploded view of the lower heater structure of the preheating station of the press apparatus;

FIG. 13 is a fragmentary horizontal cross sectional view through the center of the die set assembly of the press with the upper and lower die set units in vertically, spaced relationship and illustrating the forming die and the vacuum sheet holding frame that are a part of the forming die unit;

FIG. 14 is a fragmentary, central, vertical cross sectional view through the die set assembly of the press apparatus;

FIG. 15 is a fragmentary perspective view of mechanism for registration of an image bearing sheet outside of the die set assembly, and illustrating the heated vacuum pickup, a loading tray for the sheet material which is adjustable by power operators about X, Y and θ axes with respect to the heated vacuum pickup, and a CCD camera vision registration system independent of the heated vacuum pickup for controlling the powered X, Y and θ axis adjustment operators;

FIG. 16 is a fragmentary side elevational view of the sheet registration mechanism as illustrated in FIG. 15;

FIG. 17 is a plan view of the mechanism as shown in FIGS. 15 and 16; and

FIG. 18 is a bottom perspective view of the vacuum plate forming the part of the heated vacuum pickup and illustrating grooves which may for example correspond to perimeter areas of images on the sheet to be formed.

### DESCRIPTION OF A PREFERRED EMBODIMENT

Apparatus for high pressure, solid phase forming of relatively thin sheet material is illustrated in the drawings and broadly designated by the numeral 20. The apparatus of this invention is especially useful as an improved adaptation of hydraulically actuated ram and platen die stamping and embossing presses. Presses of this type are illustrated and described in Preco Industries, Inc.'s U.S. Pat. No. 5,212,647, which is fully incorporated herein by specific reference thereto.

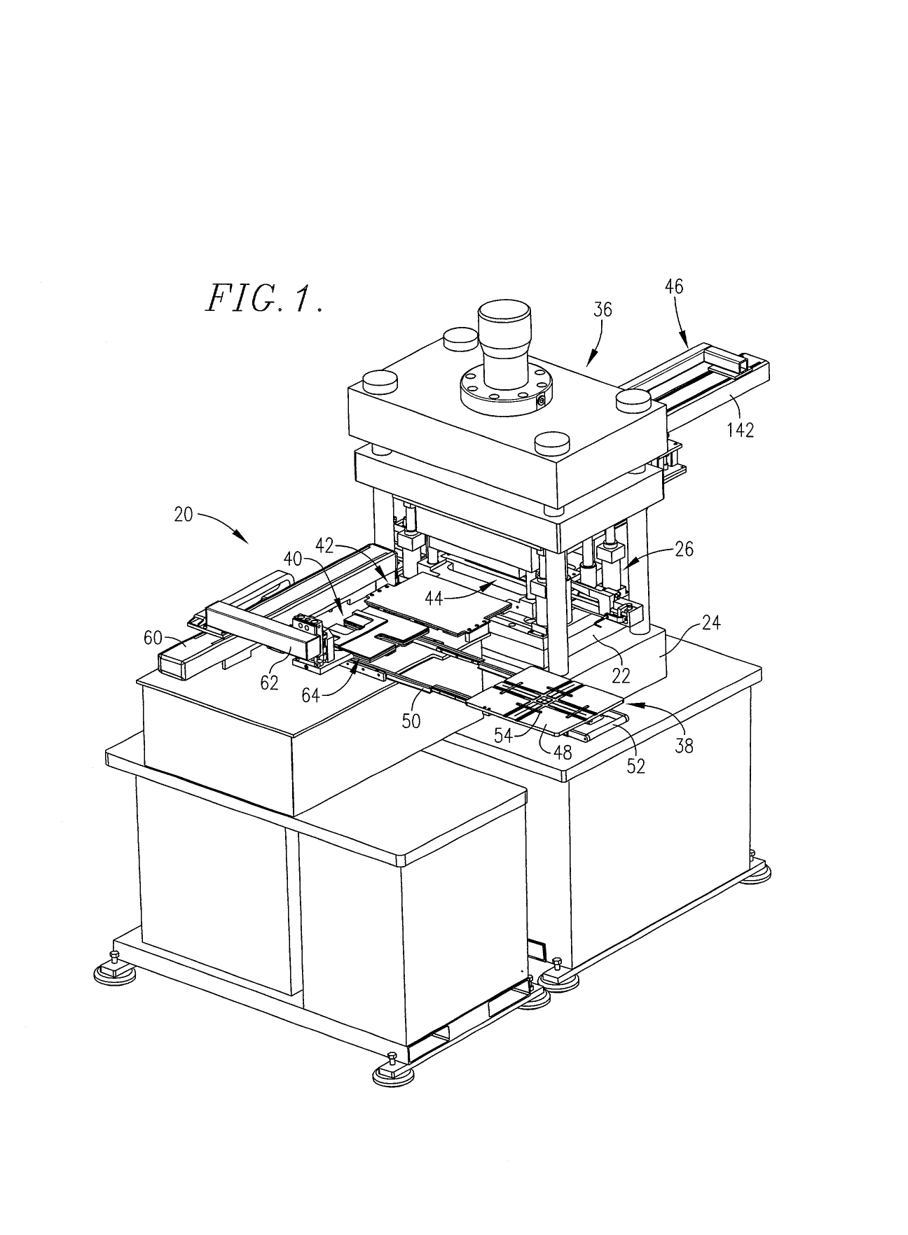

As depicted in FIGS. 1-4 and 9, and similar to the press of the '647 patent, apparatus 20 includes a floating bolster 22 mounted on a base 24 of the press and which supports a die set assembly broadly designated 26. Die set assembly 26 includes an upper high fluid pressure chamber die set unit 28 and an opposed lower forming die set unit 30 which is provided with a centrally located forming die 32. The die set assembly 26, which is supported by and rests on bolster 22, rotates and shifts with the bolster 22 as the position of the latter is adjusted by power operators as described hereinafter. The high pressure fluid die unit 30 includes carrier structure 34 forming the upper part of the die set assembly 26. The die set unit 30 which includes a high pressure fluid chamber and its associated carrier structure 34 are vertically reciprocated by the hydraulic ram structure 36 of apparatus 20.

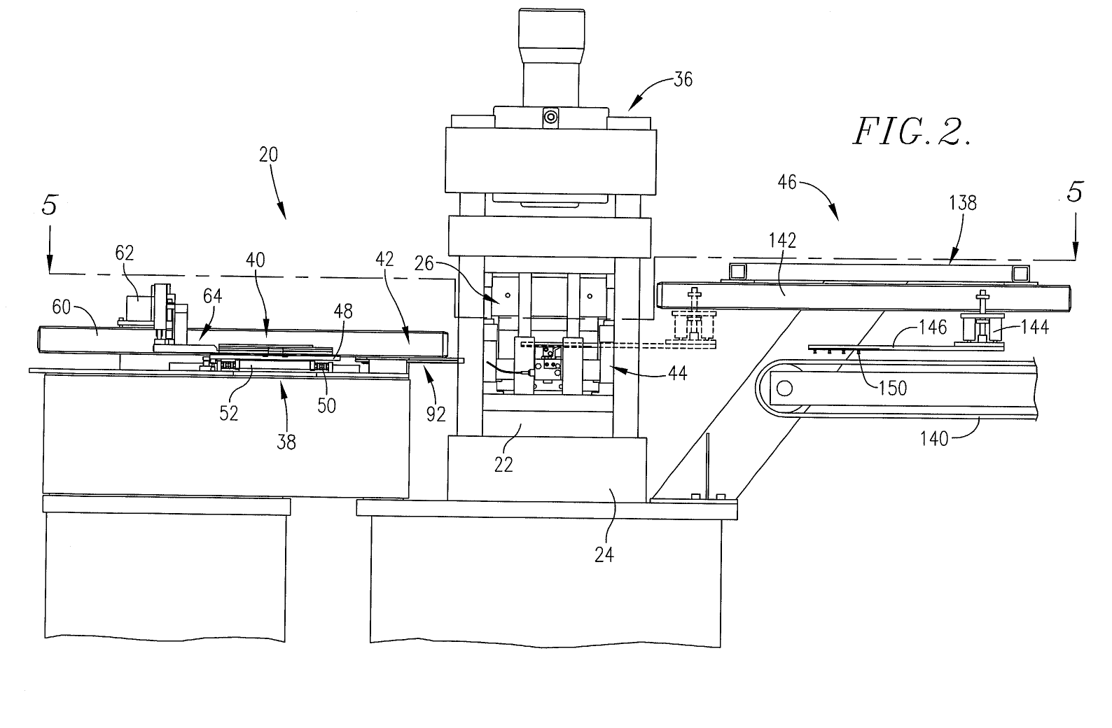

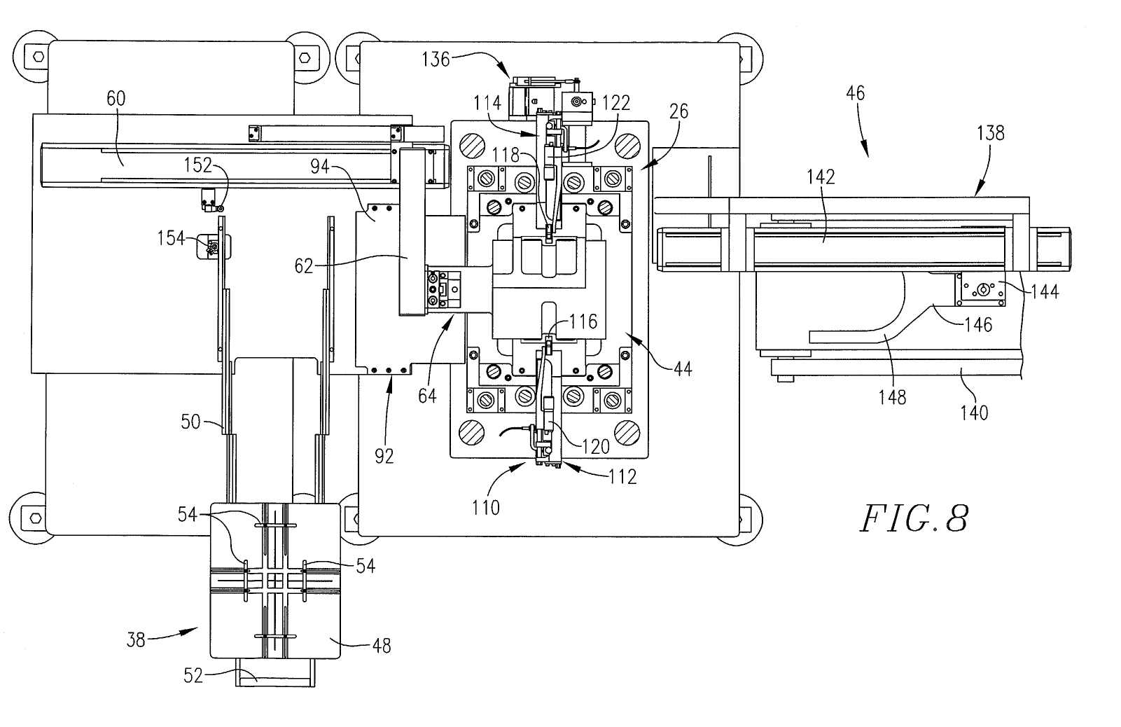

Apparatus 20 has five principle sheet handling and forming stations, including a sheet loading station 38 (FIGS. 5 and 8), a sheet pickup station 40 (FIGS. 2-4 and 6), a sheet preheat station 42 (FIGS. 2-4 and 7), a sheet forming station 44 (FIGS. 2-4 and 8), and a formed sheet removal and delivery station 46 (FIGS. 1-8).

Apparatus 20 is especially adapted for forming thin sheet material having an image imprinted thereon and in which the area to be pressure drawn and formed corresponds to or relates in a specific manner to an image or images on each sheet. Accordingly, registration of the image imprinted or otherwise presented on each sheet with the forming die of the lower die unit of die set assembly 26 is required. The registration precision requirements may vary from job to job depending upon the nature of the image as well as the depth of the area that is to be formed by the die set assembly 26. In apparatus 20 as shown in FIGS. 1-14, registration of the image of the sheet with the forming die is accomplished by X axis adjustment of the sheet with respect to the forming die and suitable Y and θ axes adjustment of the die set assembly 26 with respect to a sheet while positioned at the forming station 44 within die set assembly 26. In this respect, the X axis is defined by the longitudinal, horizontal infeed transfer path of the sheet to the die set assembly 26, the Y axis is horizontal and perpendicular to the X axis, and θ is a vertical axis of rotation that is perpendicular to the X and Y axes.

Viewing FIGS. 1, 2 and 5, for example, the loading station 38 includes a sheet support such as a tray 48 carried by horizontal collapsing track structure 50. The tray 48 has a handle 52 thereon for manual shifting of the tray 48 toward and away from the sheet pickup station 40. Tray 48 may if desired have four sheet alignment stops or guides 54 on the upper face thereof which are adjustable toward and away from one another for different sheet sizes. As is apparent from FIG. 1, each of the stops 54 is engageable with a respective side of a rectangular sheet 56 to be formed. The exemplary sheet 56 as shown in FIG. 5 has a number of images 58 which must be precisely aligned with the forming die of die set assembly 26.

It is to be noted in this respect that in the event the image or images 58 on a particular sheet of material 56 do not require registration with the forming die with the precision obtainable through use of a CCD camera vision system as for example illustrated and described in the '647 patent, the adjustable stops 54 are adequate for sheet registration. Thus, apparatus 20 may be made available without a CCD camera vision registration system as described hereinafter as a less expensive customer option for forming jobs which do not require the precision registration of a CCD camera vision system.

“Vision system” as used herein is intended to mean a registration system as for example illustrated and described in the incorporated '647 patent. A pair of CCD cameras are preferably provided along with associated prisms that allow each horizontally oriented camera to look down on alignment fiducials provided on the sheet to be formed. Digital data from the cameras is sent to a computer which in turn transmits control signals to Y and θ axis operator motors, as well as to the linear actuator 60 which shifts pickup 26 serving as the X axis adjustment function for registration of the sheet 56.

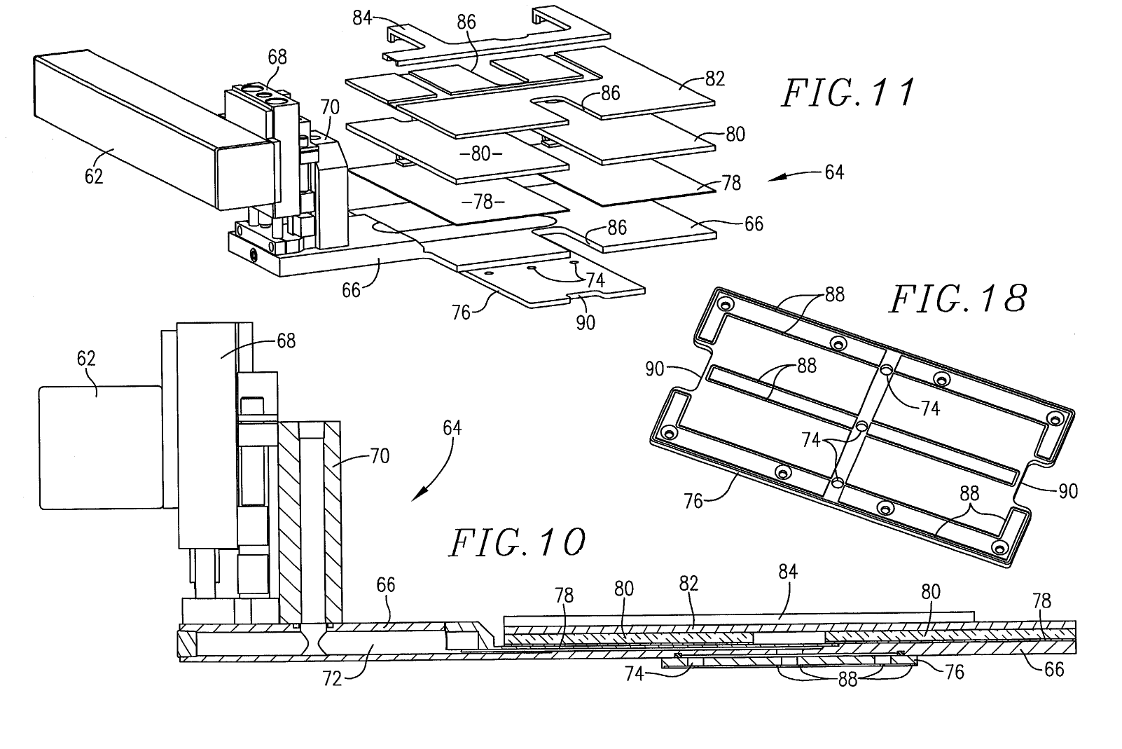

The horizontal linear actuator 60 associated with pickup station 40 carries a cantilever support arm 62 movable along the length of the actuator 60. The laminar heated vacuum pickup 64 is mounted on the outmost end of the cantilever arm 62. Pickup 64 is shiftable along the length of linear actuator 60 to and from the pickup station 40 and forming station 44 within die set assembly 26. Referring to FIGS. 10 and 11, it can be seen that the heated vacuum pickup 64 includes a mounting plate 66 connected to arm 62 through the air-operated vertical actuator 68 for up and down reciprocation of the plate 66 in response to operation of the actuator 68. A vacuum manifold block 70 connected to a source of vacuum (not shown) is carried by plate 66 adjacent vertical actuator 68 and communicates with a vacuum passage 72 extending longitudinally of the tongue portion of plate 66 underlying manifold 70 and the vertical actuator 68. The vacuum passage 72 communicates with the vacuum openings 74 in underlying vacuum plate 76.

As best shown in FIG. 18, the vacuum plate 76 may be provided with a vacuum groove or a series of vacuum grooves 88 which communicate with vacuum openings 74 in plate 76. It is contemplated that the user of apparatus 20 may utilize a vacuum plate 76 having custom configured grooves 88 therein for most effective pickup and retention of a sheet of material against the lower face of the plate 76. Accordingly, the manufacturer of apparatus 20 may supply a heated vacuum pickup 64 with a vacuum plate 76 fabricated with vacuum grooves 88 meeting the customer's specifications, or the user of the apparatus may change out plate 76 and replace that plate with another plate having vacuum grooves located to meet that customer's particular job requirements.

A thermofoil heater 78 (Minco Products, Inc. Model HM6800, 0.040″ thick thermal foil being exemplary) lies atop plate 66 and is connected to a suitable source of electrical energy. An insulator layer 80 is positioned above heater 78 while a cover plate 82 is located above the insulator layer 80. An electrical line cover 84 may be provided in overlying relationship to cover plate 82 if desired.

As is evident from FIG. 11, the layers 66, 78, 80, 82 of heated vacuum pickup 64 have aligned notches 86 in opposed fore and aft margins thereof for clearing the CCD vision registration cameras and associated prisms on opposite sides of the sheet. Aligned notches 90 in the lower vacuum plate 76 are preferably not as deep as the notches 86 in order to assure that adequate area is provided for the vacuum grooves 88 in the lower surface of plate 76. At the same time though, notches 90 are sufficiently deep to permit prism viewing of fiducials on opposite edges of the sheet material during registration of the sheet with the forming die in the forming station 44.

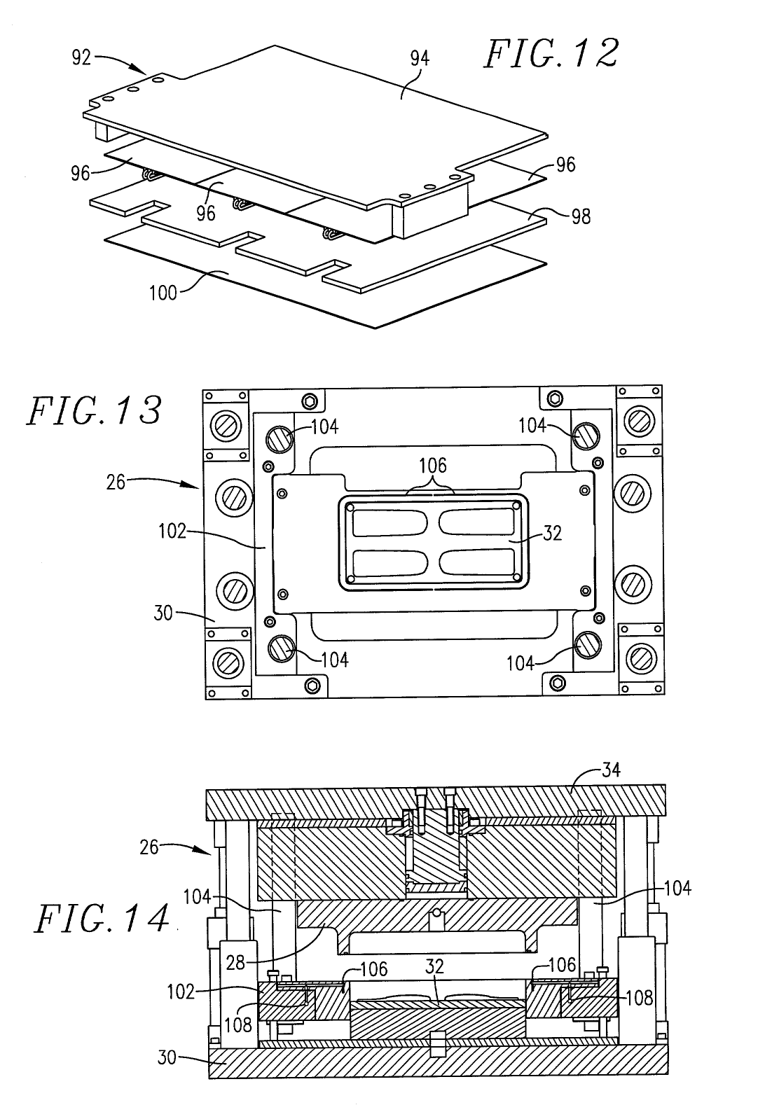

The heated vacuum pickup 64 supported by arm 62 on linear actuator 60 is movable from the pickup station 40 to preheat station 42. As best shown in FIGS. 5 and 12, lower heater structure in the form of heated plate assembly 92 at pickup station 40 includes a stationary upper plate 94 outside of but generally aligned with die set assembly 26. A heater layer 96 is positioned immediately below plate 94 and may comprise a thermal element of the same construction as the thermal element 78 of heated vacuum pickup 64. An insulator layer 98 similar to insulator layer 80 of heated vacuum pickup 64 is interposed between the heater layer 96 and lower cover plate 100. It is to be observed from FIG. 3 that the heated plate assembly 92 is positioned in disposition such that when heated vacuum pickup 64 is lowered to its down position by operation of the linear vertical actuator 68, the vacuum plate 76 of heated vacuum pickup 64 is separated from the upper surface of upper plate 94 of the assembly 92 only by the thickness of the sheet material 56. Consequently, the sheet material 56 at preheat station 42 is simultaneously subjected to direct contact heat from heated vacuum pickup 64 as well as the heated plate assembly 92.

Linear actuator 60 is of a length and is positioned such that during movement of arm 62 toward die set assembly 26 as shown in FIG. 8, the heated vacuum pickup 64 will be moved into underlying relationship to high pressure die set unit 28 and directly above the lower die set unit 30 when the die set units are in vertically spaced relationship.

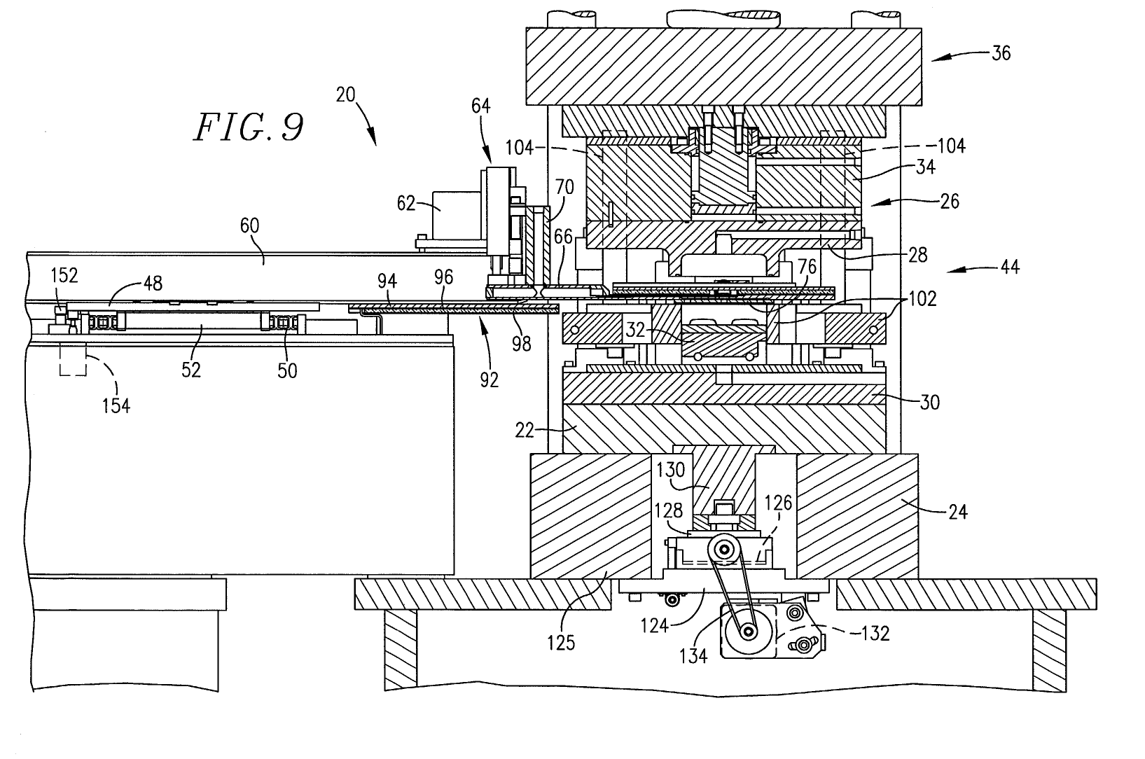

The lower die set unit 30 which includes forming die 32 also includes a sheet holder in the nature of a rectangular vacuum frame 102 having a central opening and located in surrounding relationship to die 32. The vacuum frame 102 is carried by four upright, horizontally spaced rods 104 (FIGS. 13 and 14) that are secured to carrier structure 34 of upper die set unit 28 and moveable therewith. The upper surface of frame 102 is provided with a circumferentially extending, upwardly opening vacuum groove 106 communicating with vacuum port 108 that is connected to a source of vacuum. From FIG. 9, it can be seen that when heated vacuum pickup 64 is moved to forming station 44 between vertically spaced die set units 28, 30, the vacuum plate 76 of vacuum pickup 64 is immediately above the upper surface of vacuum frame 102. The “vision system” assembly 110 of apparatus 20 preferably includes two CCD camera and prism assemblies 112, 114 which are each shiftable as a unit toward and away from the vacuum pickup 64 while the latter is at the forming station 44. As depicted in FIG. 8, shifting of the assemblies 112, 114 toward one another brings the prisms 116, 118 of assemblies 112, 114 into overlying relationship to the fiducials on respective margins of sheet 56, which are observable through the grooves 88 and notches 90 in the vacuum pickup 64. The cameras 120, 122 of assemblies 112, 114 read the position of fiducial images on sheet 56 through corresponding prisms 116, 118 and transmit digital data representative of the fiducial image positions to the control computer (not shown) for comparison with desired fiducial position data stored in the memory of the computer, all as explained in detail in the '647 patent. The CCD camera and prism assemblies 112, 114 are retracted after the required fiducial position data has been acquired.

Y axis adjustment of the sheet 56 at forming station 44 is accomplished by appropriate Y axis movement of floating bolster 22. A cross plate 124 on the frame 125 of apparatus 20 supports a horizontal, transversely extending guide 126 which slidably receives a coupling 128 that is connected by composite post structure 130 to the underside of floating bolster 22. A Y axis operator motor 132 carried by and underlying plate 124 is connected to a ball screw (not shown) which is rotated by pulley mechanism 134 connected to operator motor 132. Actuation of operator motor 132 causes the coupling 128 to slide transversely along the Y axis to thereby move the bolster 22 and thereby die set assembly 26 which is fixed to and moveable with floating bolster 22.

θ axis adjustment mechanism 136 carried by the frame 125 of apparatus 20 includes a powered operator operably connected to floating bolster 22 for rotating floating bolster 22 in required opposite directions about the vertical axis of composite post structure 130. The time interval of operation of mechanism 136 and the direction of rotation of the floating bolster 22 is controlled by the computer of the CCD vision system.

The formed sheet removal and delivery structure 138 at station 46 may include for example a horizontal off-load conveyor 140 at the outfeed side of die set assembly 26. A horizontal linear actuator 142 overlies conveyor 138 and carries a vertical linear actuator 144 which supports a vacuum plate assembly 146. In order to accommodate the raised areas that have been formed in the sheet material 56, vacuum plate assembly 146 preferably has a Y or forked-shaped vacuum member 148 provided with downwardly facing suction cups 150 connected to a source of vacuum. As shown in FIG. 2, plate assembly 146 may be shifted into overlying relationship to formed sheet material 56 resting on vacuum frame 102 to pickup the formed sheet and to deposit that sheet on the upper surface of conveyor 140.

### OPERATION OF THE PREFERRED EMBODIMENT

In the start position of apparatus 20, sheet support tray 48 is at the loading station 38, heated vacuum pickup 64 is at pickup station 40, die set units 28, 30 of die set assembly 26 are in their vertically spaced positions, and the fork-shaped vacuum member 148 of removal and delivery structure 138 is positioned as shown in FIG. 5. The alignment stops or guides 54 are adjusted to fit the dimensions of a sheet of material to be formed. Accordingly, an image bearing sheet 56 is placed on tray 48 in a position such that respective edges of the sheet 56 are in engagement with corresponding stops or guides 54.

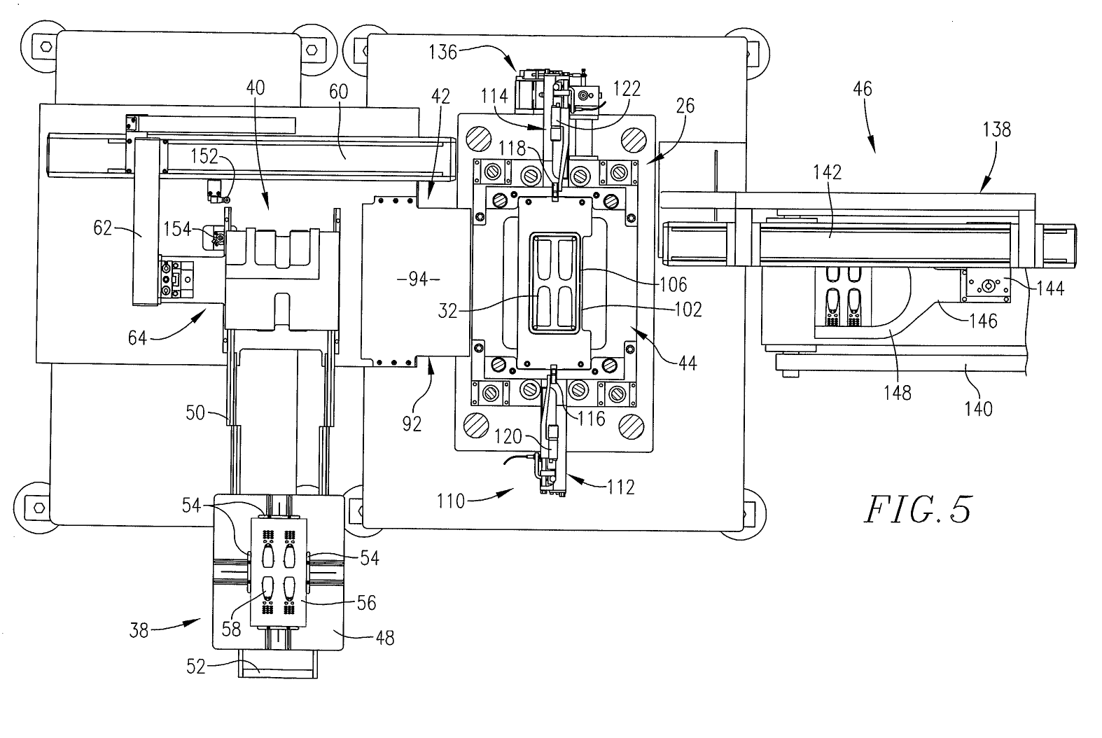

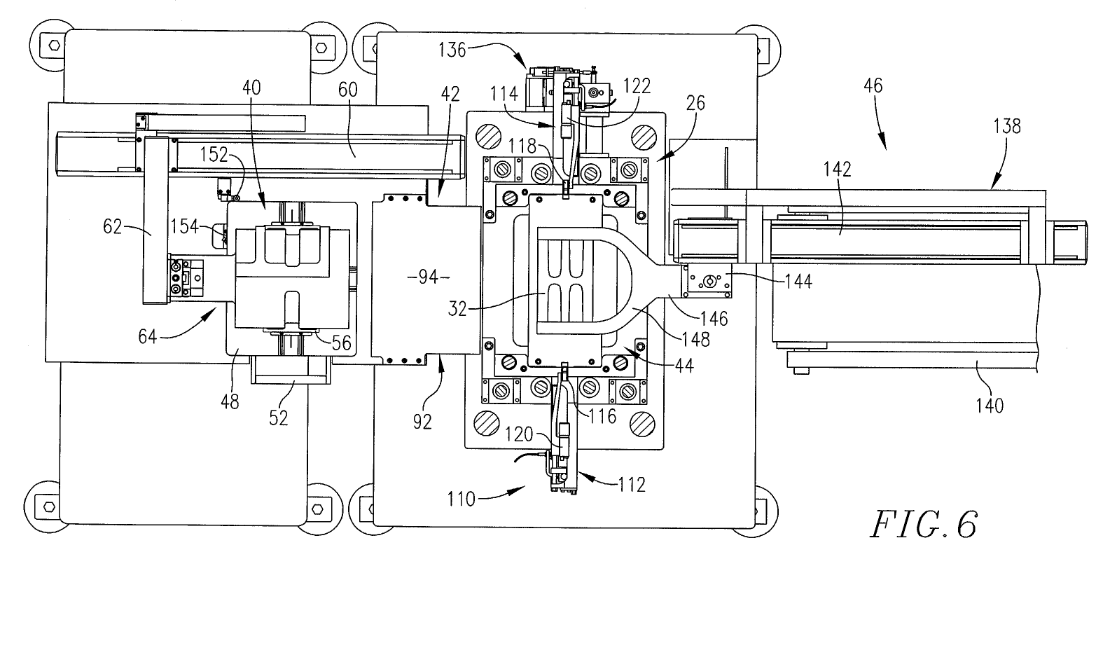

The operator of apparatus 20 grasps handle 52 of tray 48 and pushes the tray with the sheet 56 thereon into the sheet pickup station 40 immediately below heated vacuum pickup 64 as shown in FIG. 6. When the tray 48 reaches its home position in pickup station 40, the contacts of switch 152 are closed thereby actuating tray lock 154 and at the same time connecting the vacuum manifold 70 to the source of vacuum. When the tray 48 is locked in position at pickup station 40, vertical linear actuator 68 is operated to lower heated vacuum pickup 64 to a position where the vacuum plate 76 rests against the sheet of material 56 supported by tray 48. In the preferred operation of apparatus 20, electrical power is continuously supplied to the thermofoil heater 78.

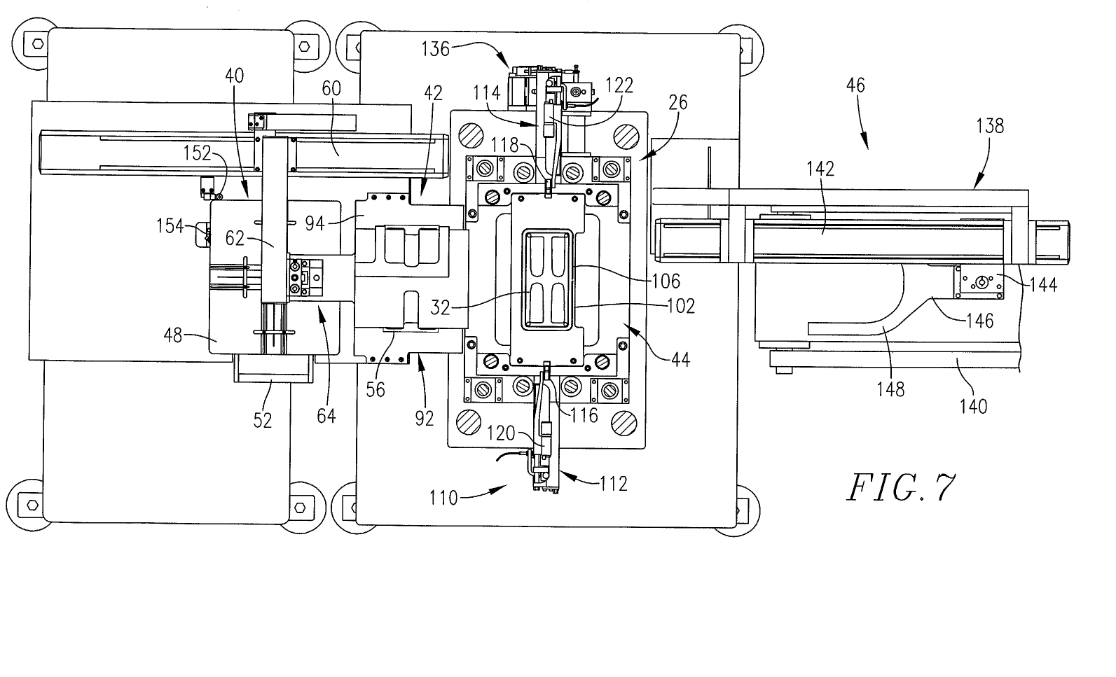

When the heated vacuum pickup 64 contacts the upper surface of sheet 56 at pickup station 40, the vacuum applied to grooves 88 of vacuum plate 76 causes the sheet 56 to adhere to the underside of plate 76 in a fixed position thereon. The heated vacuum pickup 64 is lifted by the vertical linear actuator 68 with the sheet 56 adhering to the bottom side of plate 76. Next, the horizontal linear actuator 60 is operated to cause the heated vacuum pickup 64 with the sheet 56 thereon to be shifted to the right viewing FIG. 7 into the preheat station 42. The heated vacuum pickup 64 and sheet 56 are then in direct overlying relationship to heater structure in the nature of heated plate assembly 92. The vertical linear actuator 68 is again operated to lower the heated vacuum pickup 64 to a position such that the sheet 56 is confined between plate 76 of heated vacuum pickup 64 and plate 94 of assembly 92. Heater 96 is also preferably supplied with continuous electrical energy.

The heated vacuum pickup 64 is maintained in its lowered position at preheat station 42 for a time period sufficient to preheat the sheet material 56 to a predetermined temperature level by simultaneous direct contact of the heated surfaces of heated vacuum pickup 64 and heated plate assembly 92 with opposed faces of sheet 56. In the case of IMD processes, that temperature is preferably but not necessarily below T_{G}.

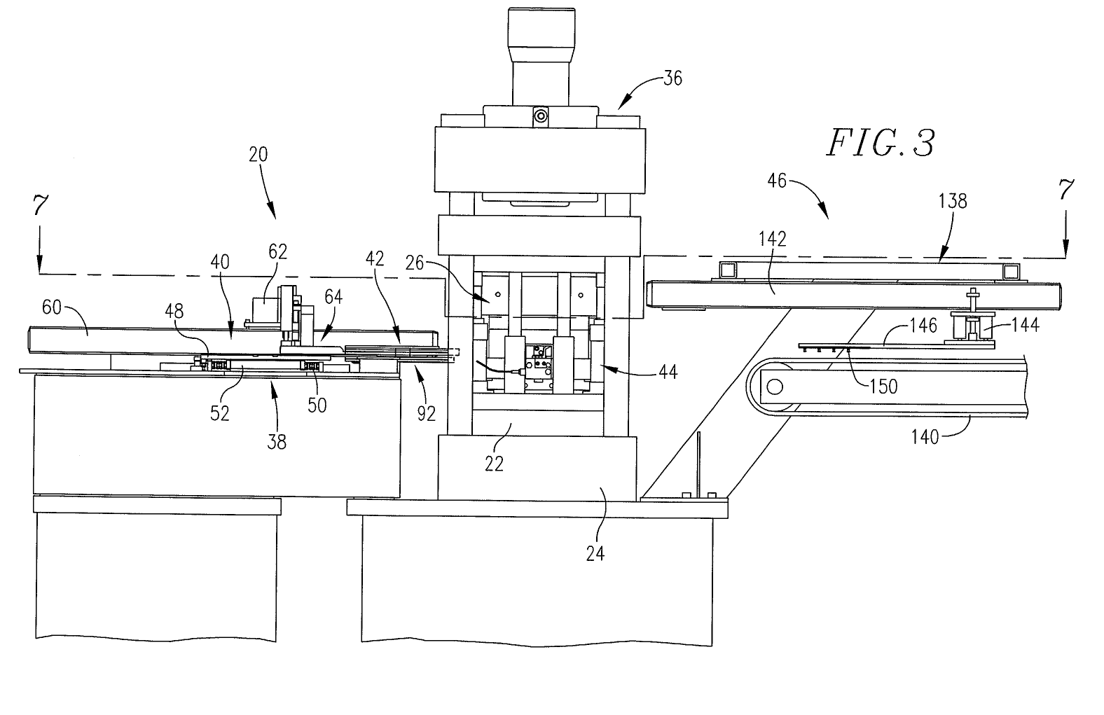

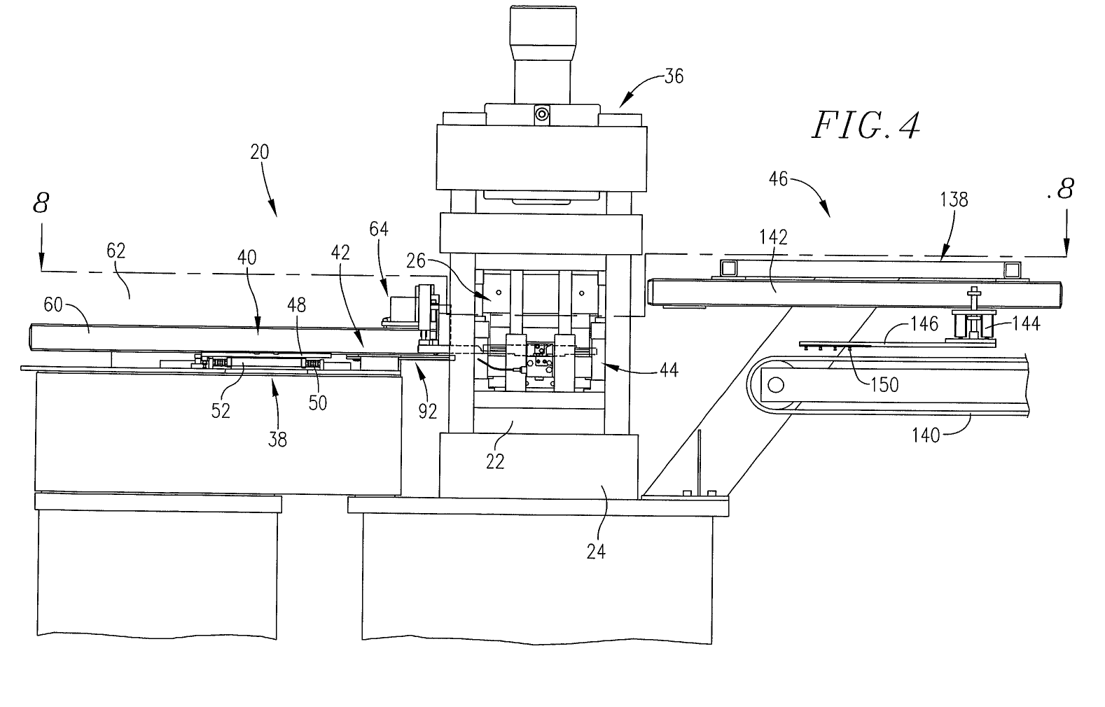

After preheating of the sheet of material 56 to a required temperature, vertical linear actuator 68 is further operated to lift heated vacuum pickup 64 to the upper end of its path of travel with the preheated sheet 56 still adhering to the underside of vacuum plate 76. Horizontal linear actuator 60 is operated to shift heated vacuum pickup 64 with sheet 56 thereon into forming station 44 between vertically spaced die set units 28, 30. It is to be seen from FIGS. 4, 8 and 9 that shifting of heated vacuum pickup 64 by horizontal linear actuator 60 is discontinued when the heated vacuum pickup 64 with the sheet 56 thereunder is directly above vacuum frame 102 and the associated forming die 32 and directly below the high fluid pressure die set unit 28.

Vision assembly 110 is activated while the heated vacuum pickup 64 is retained in its uppermost position within die set assembly 26 and while still carrying the preheated sheet 56 in order to determine the exact position of the sheet 56 with respect to the forming die 32 of the lower die set unit 30. In most instances, X, Y or θ adjustment, or combinations thereof may be required.

CCD camera assemblies 112, 114 along with associated prisms 116, 118 are shifted toward each other to bring the prisms 116, 118 into direct overlying relationship to fiducials provided on sheet material 56 in predetermined relationship with respect to the image or images 58 on the sheet 56. Camera assemblies 112, 114 read the position of the fiducials on the sheet material 56 through respective prisms 116, 118 thereby creating digital positioning data that is sent to the control computer for comparison with stored digital data representative of correct alignment of the image or images 58 on the sheet material 56 with the forming die 32.

If Y axis adjustment is required, operator motor 132 is actuated in a direction and for a time interval to cause floating bolster 22 to be shifted transversely along a path defined by guide 126 to a predetermined extent for Y axis compensation and registration. If θ axis adjustment is necessary, θ adjustment mechanism 138 is operated in a direction and for a time period to rotate floating bolster 22 in a direction and to an extent to provide θ compensation and thereby registration. X axis registration, if determined to be required by vision system 110, is accomplished by operation of the horizontal linear actuator 60 to shift pickup 64 carrying sheet 56, in a direction and through a displacement to provide required X axis compensation and registration.

After precise registration of the image bearing sheet 56 carried by heated vacuum pickup 64 with forming die 32 and which has been accomplished by transverse shifting and/or rotation of the die set support bolster 22 for Y or θ adjustment and/or operation of the horizontal linear actuator 60 for X axis adjustment, the vertical linear actuator 68 is again operated to lower the heated vacuum pickup 64 through a displacement to bring the sheet 56 into contact with the underlying vacuum frame 102. Vacuum is applied to the groove 106 of vacuum frame 102 in conjunction with release of the vacuum in grooves 88 of plate 76, thereby causing sheet material 56 to be grasped and fixedly held by frame 102 rather than heated vacuum pickup 64. The vertical linear actuator 68 is then operated to return the heated vacuum pickup 64 to its initial upper position within the confines of die set assembly 26. As soon as heated vacuum pickup 64 reaches the upper end of its path of travel within die set assembly 26, horizontal linear actuator 60 is operated to retract heated vacuum pickup 64 from the forming station 44 thereof within die set assembly 26. Continued operation of the horizontal linear actuator 60 returns the heated vacuum pickup 64 to the pickup station 40.

High fluid pressure die set unit 28 is lowered to bring the margin of the high pressure chamber thereof into engagement with the upper face of sheet material 56. Vacuum frame 102, which is carried by the rods 104 connected to upper high fluid pressure die set member 28, moves downwardly with the die set unit 28 whereby sheet material 56 is firmly clamped between die member 28 and the vacuum frame 102 of lower die set unit 30. O-ring seals may be provided on lower margin of the upper die set unit 28 and on the vacuum frame 102 to assure an adequate pressure seal, if deemed desirable.

Fluid, such as air under high pressure, is introduced into high fluid pressure chamber of die set 28 via port 156 to deep drawn the sheet and cause the portion of sheet material 56 overlying forming die 32 to closely and faithfully conform to the three-dimensional surface of the forming die 32. The fluid pressure applied to the sheet 56 which preferably has been preheated to a temperature below T_{G}, should be substantial, with exemplary temperature and pressure parameters being set forth in U.S. Pat. No. 5,108,530 which is also fully incorporated herein by specific reference thereto.

After expiration of a relatively short, predetermined period of time, the upper high fluid pressure die set member 28 is raised by the hydraulic ram of the press apparatus 20 thereby also elevating the vacuum frame 102 which is mechanically coupled to the die set member 28 by rods 104. Raising of the vacuum frame 102 with respect to the forming die 32, with the formed sheet material 56 being held on the frame 102 by the vacuum applied to groove 106, causes the formed sheet material 52 to be stripped from the upper surface of the forming die 32.

The formed material removal and delivery structure 138 is then operated to bring the fork-shaped vacuum member 148 into overlying relationship to the formed sheet material 56 still held by vacuum on the frame 102. The vertical linear actuator 144 is operated to lower fork-shaped vacuum member 148 though a displacement to bring the vacuum suction cups 150 on member 148 into contact with the upper surface of the formed sheet 56. The vacuum on frame 102 is released and the linear actuator 142 functions to remove the member 148 and the formed sheet 56 attached thereto by vacuum from between the open vertically spaced die set units 28, 30. After full retraction of the fork-shaped vacuum member 148 from die set assembly 26, the vertical linear actuator 144 is lowered to place the formed sheet material 56 onto conveyor 140 in association with release of vacuum in the suction cups 150.

In an instance where a customer is desirous of forming sheet material 56 with apparatus 20 available at a lesser cost than the apparatus 20 described above, and where registration of the image bearing sheet 56 with the forming die 32 need not be accomplished with the precision that is obtainable by vision assembly 110, the assembly 110 may be omitted from the apparatus 20. An image bearing sheet 56, when placed on the tray 48 in a position that is accurately determined by the stops or guides 54 and the tray 48 then shifted from the loading station 38 to the pickup station 40, control is maintained over the image bearing sheet 56 throughout the preheating and forming steps. The sheet 56 is always firmly held in place against the lower face of the heated vacuum pickup 64, and is retained in that same position throughout displacement of the sheet 56 to the preheat station 42, during preheating of the sheet 56, as the preheated sheet 56 is shifted from the preheat station 42 to the forming station 44 within the die set assembly 26, and during transfer of the preheated sheet 56 from heated vacuum pickup 64 to the vacuum frame 102. Thus, the initial registration obtained at the time of positioning of the sheet 56 on tray 48 is preserved throughout transfer, preheating, forming, stripping and formed sheet removal operations.

In lieu of the registration stops or guides 54 on tray 48 as illustrated in the drawings, a conventional pin registration system may be employed in which registration pins extending from the upper surface of tray 48 may be received in registration holes provided in the sheet material 56 to be formed.

Alternate Embodiment

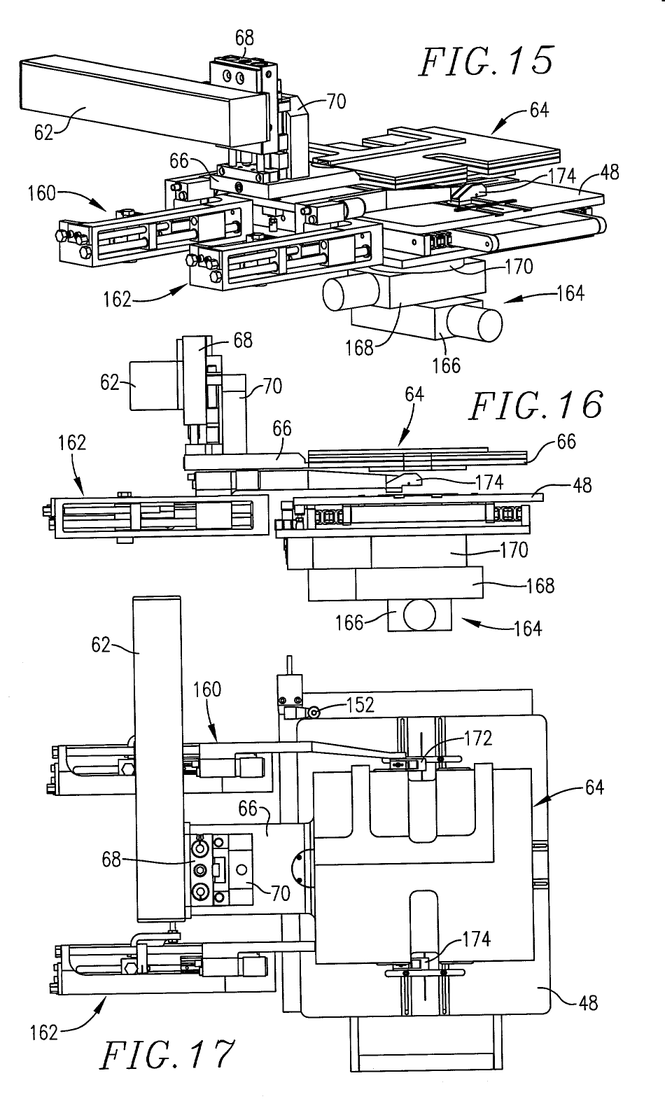

Apparatus 20 may be provided with mechanism 158 for registration of an image bearing sheet 56 with forming die 32 outside of the die set assembly 26 and in lieu of vision assembly 110. The out of die set registration mechanism 158 as depicted in FIGS. 15-17 is preferably located at pickup station 40. Two horizontally spaced, parallel CCD camera and prism assemblies 160, 162 are located beneath the cantilever arm 62 on opposite sides of the mounting plate 66 carrying vertical linear actuator 68 and vacuum manifold block 70. The support for shiftable sheet loading tray 48 in this case is mounted on a combination X, Y and θ positioning unit 164 secured to the cabinet structure of apparatus 20. The unit 164 includes an X axis positioning operator 166, a Y axis positioning operator 168 immediately above operator 166, and a θ axis operator 170 stacked above operator 168. The operator 166 is functional to shift the support for tray 48 in an X axis direction toward the die set assembly 26 parallel with linear actuator 60, the operator 168 is operable to shift the support for tray 48 in a Y axis direction perpendicular to the X axis, and operator 170 is actuated to rotate the support for tray 48 about the θ axis in a direction as required to obtain accurate registration of the image bearing sheet 56 with forming die 32.

After tray 48 with the sheet 56 thereon has been manually moved into the pickup station 40, camera and prism assemblies, 160,162 are moved to bring the prisms 172, 174 respectively thereof into overlying relationship to the fiducials on sheet 56 which are aligned with the grooves 88 and notches 90 in heated vacuum pickup 64. Digital data representing the sensed positions of the sheet 56 fiducials as sensed by the cameras of assemblies 160, 162 are transmitted to the control computer. The camera assemblies 160, 162 are then retracted and computer comparison of the actual position of the sheet fiducials with the desired pre-programed position of the fiducials results in appropriate inputs being provided to X, Y and θ adjustment operators 166, 168, 170, as previously described.

Here again, by virtue of control maintained over the sheet 56 by the vacuum adherence of the sheet 56 to heated vacuum pickup 64 throughout the entire shifting, preheating, and forming of the sheet 56, the required registration is maintained.

1. In apparatus for high pressure, solid phase forming of a relatively thin sheet having opposed surfaces, said apparatus including a die set assembly provided with a forming die set unit having a forming die and an opposed high pressure chamber die set unit, at die set assembly least one of the die set units being operable to receive said sheet at a forming station within the die set assembly when the die set units are in vertically spaced relationship, the improvement comprising:
a support for a sheet to be formed;
a sheet pickup station;
a sheet preheat station outside of the die set assembly, said preheat station being provided with sheet heater structure;
a sheet holder associated with the forming die set unit, said sheet holder and the forming die cooperating with the high pressure chamber die set unit to present a sheet forming station therebetween;
a sheet pickup operable to pick up a sheet from the support at the pickup station, said sheet pickup including heating components that cooperate with the heater structure to preheat the sheet at the preheat station;
actuator mechanism connected to the pickup for lowering the pickup at the pickup station for pick up a sheet and to then raise the pickup with the sheet thereon, for lowering the pickup and sheet at the preheat station to preheat the sheet and to then raise the pickup and preheated sheet, and for lowering the pickup at the forming station within the die set assembly accompanied by release of the sheet by the pickup;
shifting mechanism connected to said pickup and operable to sequentially shift the pickup while holding the sheet from the sheet pickup station to said preheat station, and then to the sheet forming station within the die set assembly; and
said sheet holder being operable to receive the sheet upon release of the sheet from the pickup and to hold the sheet during forming thereof after the actuator mechanism has lowered the pickup with the sheet thereon at the forming station.

2. Apparatus as set forth in claim 1 wherein said pickup shifting mechanism is a horizontal linear actuator.

3. Apparatus as set forth in claim 1 wherein the actuator for raising and lowering the pickup is a vertical linear actuator.

4. Apparatus as set forth in claim 1 wherein said pickup includes a vacuum head pickup for effecting pickup of the sheet and for holding the sheet on the pickup.

5. Apparatus as set forth in claim 1 wherein said sheet holder is a vacuum holder element for receiving and holding the sheet after release of the sheet after release from the pickup.

6. Apparatus as set forth in claim 5 wherein said vacuum holder element is a vacuum frame in surrounding relationship to the forming die.

7. Apparatus as set forth in claim 6 wherein said vacuum frame is provided with a central opening configured to receive said forming die.

8. Apparatus as set forth in claim 7 wherein said vacuum frame has a series of openings in the normally uppermost surface thereof which engages and supports the sheet at said forming station within the die set assembly.

9. Apparatus as set forth in claim 6 wherein is provided connectors for coupling the vacuum frame to the high pressure chamber die set unit for movement with the latter.

10. Apparatus as set forth in claim 6 wherein said vacuum frame is mounted for reciprocal movement with respect to the forming die of the forming die set unit along a path parallel with the path of movement of the die set units.

11. Apparatus as set forth in claim 1 wherein said sheet support is mounted for movement from a sheet loading station to said pickup station.

12. Apparatus as set forth in claim 11 wherein is provided track structure supporting the sheet support for manual movement from said loading station to said pickup station.

13. Apparatus as set forth in claim 12 wherein said sheet support is mounted for movement along a path generally at right angles to said path of travel of the vacuum head of the sheet pickup.

14. Apparatus as set forth in claim 1 wherein said sheet support is provided with guides thereon for ensuring repetitive placement of individual sheets on the support in the same position with respect to the support.

15. Apparatus as set forth in claim 1 for forming an image bearing sheet and wherein is provided a floating bolster for supporting the die set assembly, and Y and θ axis vision registration mechanism connected to the bolster for adjusting the position of the die set units with respect to the image on the sheet while the sheet is at said forming station between the vertically spaced die set units.

16. In apparatus for high pressure, solid phase forming of a relatively thin sheet having opposed surfaces, said apparatus including a die set assembly provided with a forming die set unit having a forming die and an opposed high pressure chamber die set unit, at die set assembly least one of the die set units being operable to receive said sheet at a forming station within the die set assembly when the die set units are in vertically spaced relationship, the improvement comprising:
a support for a sheet to be formed;
sheet heater structure located at a sheet preheat station outside of the die set assembly;
a sheet pickup operable to pickup a sheet from the sheet support at a sheet pickup station and to move the picked up sheet to said preheat station, said sheet pickup including heating components cooperable with the heater structure to preheat the sheet at said preheat station;
shifting mechanism operable to shift the pickup into overlying relationship to the sheet heater structure at the preheat station while the sheet is retained on the pickup;
an actuator connected to the pickup for lowering the pickup with the sheet thereon to a position with the heating components of the pickup and the heater structure disposed in sufficiently close proximity to respective opposed surfaces of said sheet therebetween to effect preheating of the sheet to a predetermined temperature,
said pickup shifting mechanism further being operable to shift the pickup with the sheet thereon to a sheet forming station between the vertically space die units of the die set assembly,
said forming die set unit including a forming die and a vacuum frame associated with the forming die,
said actuator further being operable to lower the pickup with the sheet attached thereto through a displacement to permit transfer of the sheet from the pickup to the vacuum frame,
said pickup shifting mechanism being operable to retract the pickup from the sheet forming station after the sheet has been transferred from the pickup to the vacuum frame; and
operating mechanism connected to at least one of the die units to close the die units while a preheated sheet is at said forming station between the die set units thereby permitting the sheet to be formed against the forming die upon introduction of high pressure forming fluid into the fluid pressure die unit.

17. A method for high pressure, solid phase forming of a relatively thin sheet having opposed surfaces and wherein is provided a die set assembly having a forming die set unit and an opposed high fluid pressure chamber die set unit with at least one of the die set units being movable toward and away from the opposed die set unit, and wherein the die set units are operable to receive a sheet at a forming station within the die set assembly when the die set units are vertically spaced relationship, said method comprises the steps of:
providing a support at a loading station for a sheet to be formed;
moving the supported sheet from the loading station to a pickup station;
applying a vacuum to one surface of a sheet at the pickup station to pick up the sheet;
transferring the sheet to a preheat station outside of the die set assembly while continuing application of the vacuum to said one surface of the sheet to maintain control over the position of the sheet;
heating the sheet at the preheat station by simultaneously furnishing heat to said opposed surfaces of the sheet for a predetermined interval of time while maintaining application of said vacuum to said one surface of the sheet;
shifting the preheated sheet while the vacuum is maintained on said one surface of the sheet to continue control over the sheet as it is moved into said forming station between the vertically spaced die set units of the die set assembly;
releasing the vacuum on said one surface of the sheet;
applying a vacuum to the surface of the sheet opposed to said one surface of the sheet to hold the sheet at said forming station;
bringing the die set units together to clamp the sheet therebetween;
introducing high pressure fluid into the pressure chamber member to form the sheet into a desired configuration; and
separating the die set units and then removing the formed sheet.

18. A method as set forth in claim 17 for forming an image bearing sheet comprising the steps of positioning each sheet in a reproducible, predetermined location at the loading station, and maintaining control over the position of the sheet as it is successively preheated and then shifted into the forming position thereof between the vertically spaced die set units to minimize adjustment of the die set units required for alignment of the forming die set unit with the image on the sheet.

19. A method as set forth in claim 17 wherein is included the steps of providing a moveable support for the die set assembly, and moving the die set assembly as required while an image bearing sheet is in the forming position thereof to bring the forming die of the forming die set unit into alignment with the image on the sheet.

20. A method as set forth in claim 19 wherein is included the step of moving the pickup with the sheet thereon to bring the image on the sheet into alignment with the forming die of the forming die set unit.
